(19) United States
(12) Patent Application Publication
(10) Pub. No.: US 2017/0315364 A1
(43) Pub. Date: Nov. 2, 2017

(54) VIRTUAL OBJECT DISPLAY DEVICE, METHOD, PROGRAM, AND SYSTEM

(71) Applicant: FUJIFILM Corporation, Tokyo (JP)

(72) Inventor: Jun MASUMOTO, Tokyo (JP)

(73) Assignee: FUJIFILM Corporation, Tokyo (JP)

(21) Appl. No.: 15/654,098

(22) Filed: Jul. 19, 2017

Related U.S. Application Data
(63) Continuation of application No. PCT/JP2016/052039, filed on Jan. 25, 2016.

(30) Foreign Application Priority Data
Feb. 16, 2015 (JP) 2015-027389

(51) Int. Cl. G02B 27/01; H04N 13/00; G06F 3/01; G06T 19/00

(52) U.S. Cl. CPC G02B 27/0172; H04N 13/0007; G06F 3/011; G02B 2027/014; G02B 2027/0178; G06T 19/006

(57) ABSTRACT

A camera 14 acquires a background video image B0. A virtual object acquisition unit 22 acquires a virtual object S0. A display information acquisition unit 23 acquires, from the background video image B0, display information representing a position at which the virtual object S0 is to be displayed. A display control unit 24 displays the virtual object S0 on a display 15 on the basis of the display information. A change information acquisition unit 25 acquires, from the background video image B0, change information used to change a display state of the virtual object S0. A display state changing unit 26 changes the display state of the virtual object in accordance with the change information. A set amount display control unit 27 displays on the display 15 information representing a set amount of the display state of the virtual object S0.

### CROSS-REFERENCE TO RELATED APPLICATIONS

This application is a Continuation of PCT International Application No. PCT/JP2016/052039 filed on Jan. 25, 2016, which claims priority under 35 U.S.C §119(a) to Patent Application No. 2015-027389 filed in Japan on Feb. 16, 2015, all of which are hereby expressly incorporated by reference into the present application.

### BACKGROUND OF THE INVENTION

### 1. Field of the Invention

The present invention relates to a virtual object display device, method, non-transitory computer-readable recording medium storing a program, and system that enable a display state of a virtual object to be changed in the case where the virtual object is displayed by using augmented reality, for example.

### 2. Description of the Related Art

In recent years, there have been proposed display systems using augmented reality that enables a virtual object to appear to exist in a real space by superimposing the virtual object on a real-time background video image obtained by imaging the real space and by displaying the resultant combined image on a display device, such as a head-mounted display. In such systems, a marker that defines a position at which the virtual object is to be displayed is placed in the real space. The marker is then detected from the background video image that is obtained by imaging the real space. Further, the position at which and the size and orientation in which the virtual object is to be displayed is determined in accordance with the position, size, and orientation of the detected marker, and the virtual object is displayed at the determined display position in the determined size and orientation on the display device. An image, such as a two-dimensional barcode, is used as such a marker. Techniques that enable the use of an LED (Light Emitting Diode) or an operator's finger as the marker have also been proposed.

In addition, some kind of operation can be performed on the displayed virtual object. For example, there has been proposed a technique for imaging a marker on which various patterns are drawn and for triggering an event associated with a corresponding pattern when the marker displayed by using augmented reality touches a virtual object (see Japanese Unexamined Patent Application Publication No. 2011-198150 (hereinafter, referred to as PTL 1)). The technique described in PTL 1 triggers an event for deleting the displayed virtual object or an event for replacing the displayed virtual object with another virtual object. In addition, there have also been proposed a technique for including a finger of an operator in a background video image and for allowing the operator to operate a virtual object by moving the finger like a cursor (see Japanese Unexamined Patent Application Publication No. 2013-105330 (hereinafter, referred to as PTL 2)) and a technique for displaying, by using augmented reality, an operation interface used to operate a virtual object and for allowing a user to perform an operation on the virtual object by using the displayed operation interface (see Japanese Unexamined Patent Application Publication No. 2013-172432 (hereinafter, referred to as PTL 3)).

Furthermore, in the medical field, participants of a surgery gather together prior to the surgery and hold a pre-surgery conference for explaining the surgery. During such a pre-surgery conference, augmented reality has come into use to display a target site of the surgery and to simulate the surgery in recent years. For example, for partial hepatic resection surgery, tissues of the liver, the portal vein, the veins, the arteries, the body surface, the bones, and the tumor are extracted from a three-dimensional image obtained from sectional images such as CT (Computed Tomography) images or MRI (magnetic resonance imaging) images, and these are visualized as three-dimensional images to generate a virtual object of the liver. The virtual object is then displayed in actual size by using augmented reality. By using the displayed virtual object, an explanation is given to the participants of the pre-surgery conference by the surgeon who is a representative of the conference and the surgical procedure is simulated. At that time, all the participants of the conference can proceed with the conference while viewing a common virtual object by wearing display devices, such as head-mounted displays.

In terms of applications of such display systems using augmented reality in the medical field, there has been proposed a technique for displaying a virtual object of a target of a surgery on a head-mounted display to be superimposed on a real-world object, such as a medical instrument, for switching between showing and hiding of the virtual object in accordance with an instruction from the surgeon, and for enlarging/reducing the virtual object in accordance with a distance to the object (see Japanese Unexamined Patent Application Publication No. 2014-155207 (hereinafter, referred to as PTL 4)). In addition, there has also been proposed a technique for displaying a virtual object on a head-mounted display worn by each person, for detecting an object such as a scalpel, and for switching between the enlarged display, the transparent display, and so on of the virtual object in response to an operation of the object (see International Publication No. 2012/081194 (hereinafter, referred to as PTL 5)). Further, there has been proposed a technique for changing the position, orientation, and inclination of each corresponding object in response to movement of a marker in the case where virtual objects are displayed by using markers as references (see Japanese Unexamined Patent Application Publication No. 2014-010664 (hereinafter, referred to as PTL 6)).

### SUMMARY OF THE INVENTION

By changing display states such as color, brightness, opacity, etc. of a virtual object displayed by using augmented reality, the virtual object can be displayed in various display states. In such a case, it is conceivable to change the display state of the virtual object by performing an operation in accordance with the techniques described in PTL 1 to PTL 3.

However, the techniques described in PTL 1 and PTL 2 are for performing an operation on a virtual object displayed using augmented reality by moving toward the virtual object a video image of a finger or the like additionally displayed on the screen. For this reason, if the position of the displayed virtual object changes due to a change in the orientation of the face of the operator or the like, it becomes difficult to perform a movement operation for moving the video image of the finger or the like. In addition, when the virtual object is displayed in a small size, an operation amount of the finger or the like for the operation is small. Thus, it becomes more difficult to perform the movement operation for moving the video image of the finger or the like. Further, according to the technique described in PTL 3, since the operation interface is also displayed by using augmented reality, the operation is performed on the space instead of an object. For this reason, there is no real sensation, such as a sensation of pressing a button, and it is difficult to perform an operation for subtly changing the display state. Thus, the use of hardware for changing the display state of the virtual object, such as an input device, is conceivable. However, in such a case, hardware needs to be prepared separately, and a complex application for changing the display state of the virtual object by using the hardware is further needed.

In addition, the techniques described in PTL 4 to PTL 6 are for enlarging/reducing the virtual object and switching between showing and hiding of the virtual object in accordance with the distance between an object or marker and the virtual object. However, just like the techniques described in PTL 1 and PTL 2, if the position of the displayed virtual object changes due to a change in the orientation of the face of the operator or the like, it becomes difficult to perform the operation for changing. It is also difficult to perform the operation for subtly changing the display state of the virtual object.

The present invention has been made in view of the above circumstances and aims to enable the display state of a virtual object to be accurately changed.

A virtual object display device according to an aspect of the present invention includes imaging unit that acquires a background video image; virtual object acquisition unit that acquires a virtual object; display unit on which the virtual object is displayed; display information acquisition unit that acquires, from the background video image, display information representing a position at which the virtual object is to be displayed; display control unit that displays the virtual object on the display unit on the basis of the display information; change information acquisition unit that acquires, from the background video image, change information used to change a display state of the virtual object; display state changing unit that changes the display state of the virtual object in accordance with the change information; and set amount display control unit that displays, on the display unit, information representing a set amount of the display state of the virtual object.

The “background video image” is a video image that serves as a background on which a virtual object is displayed and is, for example, a video image of a real space. Note that the background video image is a motion picture obtained by successively imaging, at a predetermined sampling interval, the background on which the virtual object is displayed.

The “display information” is information included in the background video image as a result of imaging an object that is used to display the virtual object and that is placed in a real space to identify a position at which and, if necessary, at least one of a size and an orientation in which the virtual object is to be displayed. For example, a two-dimensional barcode, a maker assigned a color or a pattern, a marker such as an LED, some kind of instrument, body part of the operator such as a finger, and a feature point such as an edge or an intersection point of edges of an object included in the background video image can be used as the object that is used to display the virtual object. In the case where a marker is used, the display information is acquired from a marker image that is included in the background video image and that represents the marker.

The “change information” is information included in the background video image as a result of imaging an object that is used to change the display state of the virtual object and that is placed, in order to change the display state of the virtual object, in the real space where the operator is present. For example, a two-dimensional barcode, a marker assigned a color or a pattern, a marker such as an LED, some kind of instrument, and body part of the operator such as a finger can be used as the object that is used to change the display state of the virtual object. In the case where a marker is used, the change information is acquired from a marker image that is included in the background video image and that represents the marker.

“To change the display state” refers to changing the state of the virtual object that visually appeals to a viewer of the virtual object. For example, “to change the display state” refers to changing the color, brightness, contrast, opacity, sharpness, and the like of the virtual object. In the case of the virtual object whose shape changes over time as a result of an operation on the virtual object, the change in shape over time is also included in the change in the display state. In addition, in the case where the virtual object includes a plurality of objects, the display state may be changed for each of the objects.

The “information representing a set amount” is information that allows a viewer to recognize the set amount of the display state of the displayed virtual object by viewing the information. For example, information capable of representing a set amount, such as a numerical value, a pie chart, a bar chart, and a graduated scale that represent the set amount, can be used as the “information representing the set amount”.

In addition, in the virtual object display device according to the aspect of the present invention, the background video image may be acquired by imaging a background that corresponds to a field of view of a user.

In addition, in the virtual object display device according to the aspect of the present invention, the display information may further include at least one of a size and an orientation in which the virtual object is to be displayed.

In addition, in the virtual object display device according to the aspect of the present invention, the display unit may combine the virtual object with the background video image and may display a resultant combined image.

In addition, in the virtual object display device according to the aspect of the present invention, the display information acquisition unit may acquire the display information from a first marker image that is included in the background video image as a result of imaging a first marker used to display the virtual object and that represents the first marker.

In addition, in the virtual object display device according to the aspect of the present invention, the change information acquisition unit may acquire the change information from a second marker image that is included in the background video image as a result of imaging at least one second marker used to change the display state of the virtual object and that represents the second marker.

In addition, in the virtual object display device according to the aspect of the present invention, the change information may represent an amount of change of the second marker from a reference position.

In addition, in the virtual object display device according to the aspect of the present invention, the set amount display control unit may display the information representing the set amount to be adjacent to the second marker image.

“To be adjacent” indicates a distance at which the viewer can observe both the second marker image and the information representing the set amount without moving the line of sight. Note that “to be adjacent” encompasses both the states where the second marker image and the information representing the set amount are in contact with each other and are superimposed with each other.

In addition, in the virtual object display device according to the aspect of the present invention, the second marker may be a polyhedron having faces each of which is assigned information used to change the display state.

In addition, in the virtual object display device according to the aspect of the present invention, the polyhedron may be a cube.

In addition, in the virtual object display device according to the aspect of the present invention, the virtual object may include a plurality of objects, the change information acquisition unit may acquire a plurality of pieces of object change information each for changing a display state of a corresponding one of the plurality of objects, the display state changing unit may change the display state of each of the plurality of objects in accordance with a corresponding one of the pieces of object change information, and the set amount display unit may display, for each of the plurality of objects, information representing a set amount for the object on the display unit.

In addition, in the virtual object display device according to the aspect of the present invention, the virtual object may be a three-dimensional image.

In particular, the three-dimensional image may be a three-dimensional medical image.

In addition, in the virtual object display device according to the aspect of the present invention, the display unit may be an eyeglass-shaped display device.

Examples of the “eyeglass-shaped display device” include a head-mounted display and a display device of an eyeglass-shaped wearable terminal. Further, the “eyeglass-shaped display device” may be of an immersive type that completely covers the eyes or of a see-through type that allows the wearer to see the surroundings.

Further, a virtual object display system according to another aspect of the present invention includes a plurality of the virtual object display devices according to the aspect of the present invention, each of the plurality of virtual object display devices corresponding to one of a plurality of users, wherein the display state changing unit of each of the plurality of virtual object display devices changes the display state of the virtual object in accordance with the change information acquired by the change information acquisition unit of any one of the virtual object display devices.

Another virtual object display system according to still another aspect of the present invention includes a plurality of the virtual object display devices according to the aspect of the present invention, each of the plurality of virtual object display devices corresponding to one of a plurality of users, wherein the display state changing unit of each of the plurality of virtual object display devices changes the display state of the virtual object in accordance with the change information acquired by the change information acquisition unit of the virtual object display device.

A virtual object display method according to yet another aspect of the present invention includes acquiring a background video image; acquiring a virtual object; acquiring, from the background video image, display information representing a position at which the virtual object is to be displayed; displaying the virtual object on display unit on the basis of the display information; acquiring, from the background video image, change information used to change a display state of the virtual object; changing the display state of the virtual object in accordance with the change information; and displaying, on the display unit, information representing a set amount of the display state of the virtual object.

Note that a non-transitory computer-readable recording medium storing a program for causing a computer to execute the virtual object display method according to the yet another aspect of the present invention may also be provided.

According to the aspects of the present invention, a virtual object is displayed on the basis of display information, and a display state of the virtual object is changed in accordance with change information. Information representing a set amount of the display state of the virtual object is also displayed. Thus, the viewer can recognize the set value of the current display state of the virtual object by viewing the displayed information representing the set amount and consequently can accurately change the display state of the virtual object.

### BRIEF DESCRIPTION OF THE DRAWINGS

FIG. 1 is a diagram for describing a circumstance where virtual object display devices according to a first embodiment of the present invention are used;

FIG. 2 is a hardware configuration diagram illustrating the overview of a virtual object display system that employs the virtual object display devices according to the first embodiment;

FIG. 3 is a block diagram illustrating a schematic configuration of a head-mounted display which is the virtual object display device;

FIG. 4 is a diagram illustrating an example of a virtual object;

FIG. 5 is a diagram illustrating a first marker;

FIG. 6 is a diagram illustrating the first marker placed at a place where a pre-surgery conference is held;

FIG. 7 is a diagram illustrating a first marker image extracted from a background video image;

FIG. 8 is a diagram schematically illustrating the display state of the virtual object at the place where the pre-surgery conference is held;

FIG. 9 is a diagram illustrating a second marker;

FIG. 10 is a diagram for describing changing of inclination of the second marker;

FIG. 11 is a diagram for describing acquisition of change information by using two second markers;

FIG. 12 is a diagram for describing acquisition of change information by using the first marker and the second marker;

FIG. 13 is a diagram for describing display of information representing a set amount;

FIG. 14 is a diagram for describing display of the information representing the set amount;

FIG. 15 is a flowchart illustrating a process performed in the first embodiment;

FIG. 16 is a diagram illustrating second markers used in a second embodiment;

FIG. 17 is a diagram illustrating the second markers used in the second embodiment; and

FIG. 18 is a diagram for describing a change in the display state of the virtual object for displaying the liver in a resected state.

### DESCRIPTION OF THE PREFERRED EMBODIMENTS

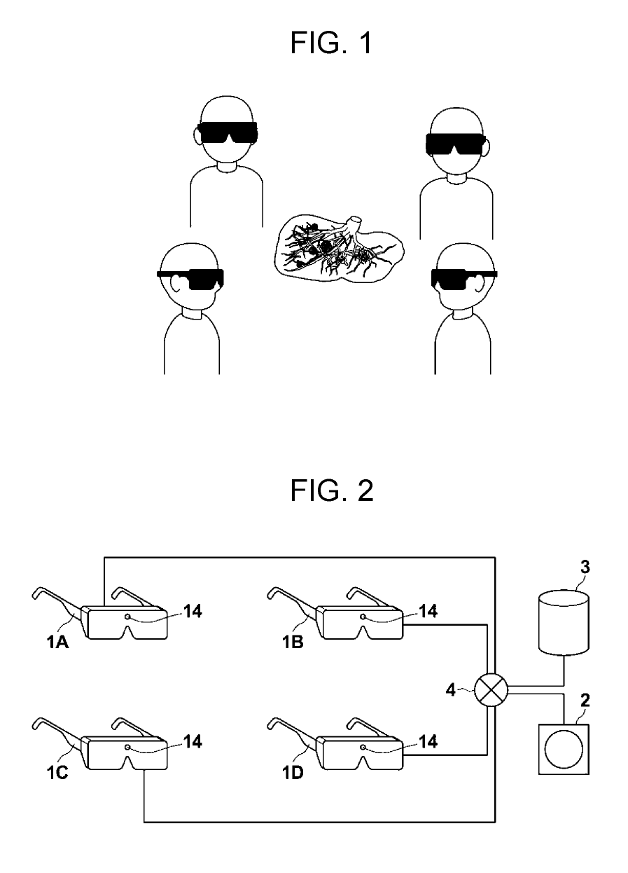

Embodiments of the present invention will be described below with reference to the drawings. FIG. 1 is a diagram for describing a circumstance where virtual object display devices according to a first embodiment of the present invention are used. The virtual object display devices according to the first embodiment are for displaying a three-dimensional image of the liver, which is the target of a surgery, as a virtual object by using augmented reality during a pre-surgery conference. Specifically, the virtual object display devices are used in a circumstance where a three-dimensional image of the liver is generated as a virtual object from a three-dimensional image obtained by imaging a subject and where each participant of the surgery wears a head-mounted display (hereinafter, abbreviated as HMD) to display the virtual object on the HMD and receives various explanations regarding the surgery from the surgeon who is a representative of the pre-surgery conference during the pre-surgery conference. Note that the virtual object display device according to an aspect of the present invention is included in the HMD.

FIG. 2 is a hardware configuration diagram illustrating the overview of a virtual object display system that employs the virtual object display devices according to the first embodiment. As illustrated in FIG. 2, in this system, a plurality of (four in this embodiment) HMDs 1A to 1D each including the virtual object display device according to the first embodiment, a three-dimensional imaging apparatus 2, and an image storage server 3 are connected to one another to be able to perform communication via a network 4. In addition, information can be exchanged among the HMDs 1A to 1D via the network 4. Note that each of the HMDs 1A to 1D corresponds to the virtual object display device according to an aspect of the present invention. Further, it is assumed in the following description that the four HMDs 1A to 1D are sometimes represented by HMDs 1.

The three-dimensional imaging apparatus 2 is an apparatus that images a surgery-target site of a subject to generate a three-dimensional image V0 representing that site. Specifically, the three-dimensional imaging apparatus 2 is an apparatus, such as a CT apparatus, an MRI apparatus, or a PET (Positron Emission Tomography) apparatus. The three-dimensional image V0 generated by this three-dimensional imaging apparatus 2 is transmitted to and stored in the image storage server 3. Note that it is assumed in this embodiment that the surgery-target site of the subject is the liver, the three-dimensional imaging apparatus 2 is a CT apparatus, and the three-dimensional image V0 of the abdominal part is generated.

The image storage server 3 is a computer that stores and manages various kinds of data. The image storage server 3 includes a mass external storage device and database management software. The image storage server 3 communicates with other devices via the network 4, which is wired or wireless, to transmit and receive image data or the like. Specifically, the image storage server 3 acquires, via the network 4, image data of the three-dimensional image V0 generated by the three-dimensional imaging apparatus 2 or the like and stores and manages the image data on a recording medium, such as the mass external storage device. Note that the storage format of image data and communication between the devices via the network 4 are based on a protocol, such as DICOM (Digital Imaging and COmmunication in Medicine).

The HMD 1 includes a computer, and a virtual object display program according to an aspect of the present invention is installed on the computer. The virtual object display program is installed in a memory of the HMD 1. Alternatively, the virtual object display program is stored in a storage device of a server computer connected to the network or a network storage to be accessible from the outside and is downloaded to and installed on the HMD 1 in response to a request.

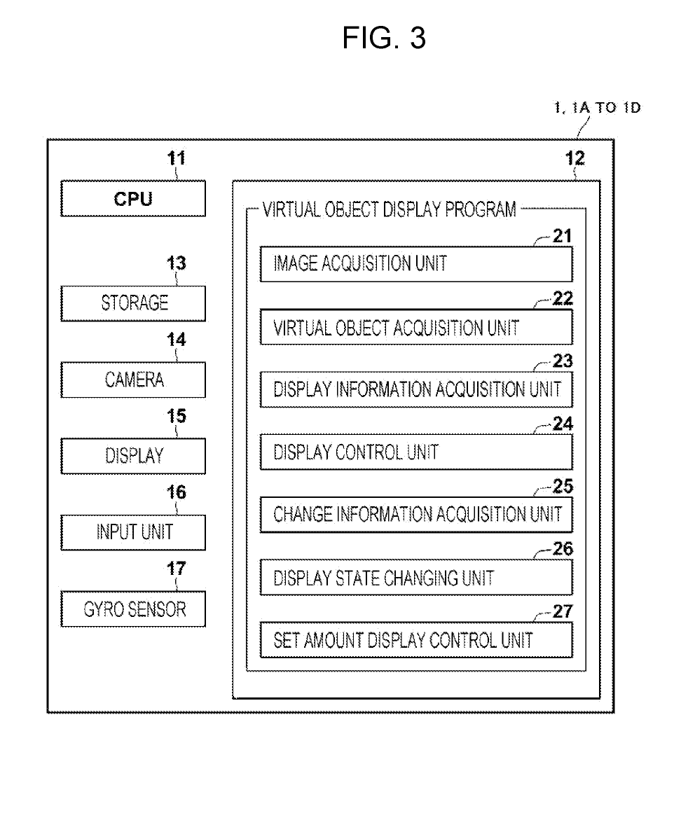

FIG. 3 is a block diagram illustrating a schematic configuration of the HMD 1 that is a virtual object display device implemented by installation of the virtual object display program. As illustrated in FIG. 3, the HMD 1 includes a CPU (Central Processing Unit) 11, a memory 12, a storage 13, a camera 14, a display 15, and an input unit 16. The HMD 1 also includes a gyro sensor 17 for detecting movement of the head of the wearer of the HMD 1. Note that the camera 14 corresponds to imaging unit according to an aspect of the present invention, and the display 15 corresponds to display unit according to an aspect of the present invention. In addition, the camera 14, the display 15, and the gyro sensor 17 may be provided in a head-worn portion of the HMD 1, and the memory 12, the storage 13, and the input unit 16 may be provided separately from the head-worn portion.

The storage 13 stores various kinds of information including the three-dimensional image V0 acquired from the image storage server 3 via the network 4 and images generated by processing performed by the HMD 1.

The camera 14 includes a lens, a CCD (Charge Coupled Device) imaging element or the like, and an image processing unit that performs processing for improving the image quality of an acquired image. As illustrated in FIG. 2, the camera 14 is attached to the HMD 1 to be located at a portion of the HMD 1 corresponding to the center between the eyes of the participant. With this arrangement, when the participant of the pre-surgery conference wears the HMD 1, the field of view of the wearer matches the imaging range of the camera 14. Thus, when the participant wears the HMD 1, the camera 14 captures images corresponding to the field of view of the participant and acquires a video image of the real space viewed by the participant as a background video image B0. The background video image B0 is a motion picture having a predetermined frame rate.

The display 15 includes a liquid crystal panel or the like for displaying the background video image B0 and a virtual object S0. Note that the display 15 includes a display unit for the left eye and a display unit for the right eye of the wearer of the HMD 1.

The input unit 16 includes buttons, for example, and is provided at a predetermined position of the exterior of the HMD 1.

In addition, the memory 12 stores the virtual object display program. The virtual object display program defines, as processes which the program causes the CPU 11 to execute, an image acquisition process of acquiring the three-dimensional image V0 acquired by the three-dimensional imaging apparatus 2 and the background video image B0 acquired by the camera 14, a virtual object acquisition process of acquiring a virtual object, a display information acquisition process of acquiring, from the background video image B0, display information representing the position at which and the size and orientation in which the virtual object is to be displayed, a display control process of displaying the background video image B0 on the display 15 and displaying the virtual object on the display 15 on the basis of the display information, a change information acquisition process of acquiring, from the background video image B0, change information used to change the display state of the virtual object, a display state changing process of changing the display state of the virtual object in accordance with the change information, and a set amount display control process of displaying, on the display 15, information representing a set amount of the display state of the virtual object.

As a result of the CPU 11 executing these processes in accordance with the program, the HMD 1 functions as an image acquisition unit 21, a virtual object acquisition unit 22 (virtual object acquisition means), a display information acquisition unit 23 (display information acquisition means), a display control unit 24 (display control means), a change information acquisition unit 25 (change information acquisition means), a display state changing unit 26 (display state changing means), and a set amount display control unit 27 (set amount display control means). Note that the HMD 1 may include processing devices each of which performs a corresponding one of the image acquisition process, the virtual object acquisition process, the display information acquisition process, the display control process, the change information acquisition process, the display state changing process, and the set amount display control process.

The image acquisition unit 21 acquires the three-dimensional image V0 and the background video image B0 that is captured by the camera 14. In the case where the three-dimensional image V0 is already stored in the storage 13, the image acquisition unit 21 may acquire the three-dimensional image V0 from the storage 13.

The virtual object acquisition unit 22 generates, as a virtual object, a three-dimensional image of the liver which is the surgery-target site. To this end, the virtual object acquisition unit 22 first extracts, from the three-dimensional image V0, the liver which is the surgery-target site and the arteries, veins, portal vein, and lesion included in the liver. The virtual object acquisition unit 22 includes a classifier that determines whether each pixel of the three-dimensional image V0 is a pixel representing the liver and the arteries, veins, portal vein, and lesion included in the liver (hereinafter, referred to as the liver and so on). The classifier is obtained by performing machine learning of a plurality of sample images including the liver and so on by using a method, for example, the Adaptive Boosting algorithm. The virtual object acquisition unit 22 extracts the liver and so on from the three-dimensional image V0 by using the classifier.

The virtual object acquisition unit 22 then generates, as the virtual object S0, an image representing the three-dimensional shape of the liver and so on. Specifically, the virtual object acquisition unit 22 generates, as the virtual object S0, a projection image obtained by projecting the extracted liver and so on onto a projection plane determined by display information described later. Here, for example, a known volume rendering technique or the like is used as a specific projection method.

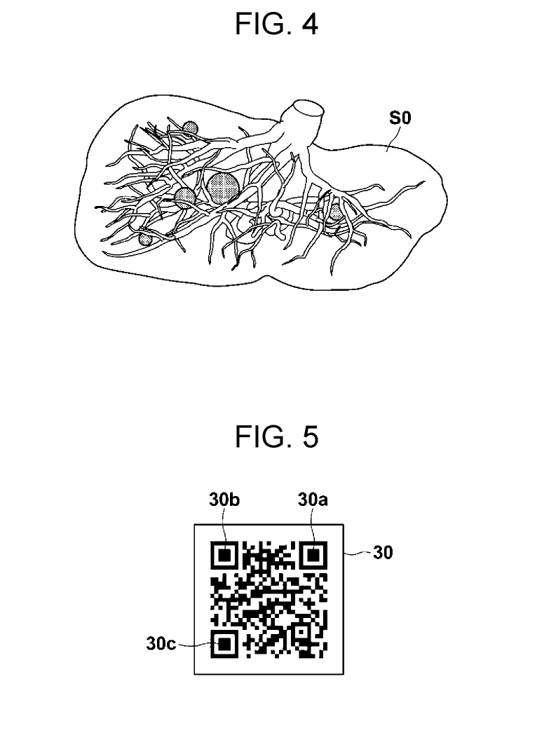

At that time, the virtual object S0 may be generated by defining different colors for the liver and the arteries, veins, portal vein, and lesion included in the liver, or the virtual object S0 may be generated by defining different opacities. For example, the arteries, the veins, the portal vein, and the lesion may be displayed in red, blue, green, and yellow, respectively. In addition, the opacity of the liver, the opacity of the arteries, veins, and portal vein, and the opacity of the lesion may be set to 0.1, 0.5, and 0.8, respectively. In this way, the virtual object S0 illustrated in FIG. 4 is generated. By defining in the virtual object S0 different colors or opacities for the liver and the arteries, veins, portal vein, and lesion included in the liver in this way, the liver and the arteries, veins, portal vein, and lesion included in the liver can be easily distinguished from one another. Note that the virtual object S0 may be generated by defining both different colors and different opacities. The generated virtual object S0 is stored in the storage 13.

Alternatively, a virtual object generation device, not illustrated, may generate the virtual object S0 from the three-dimensional image V0 and may store the virtual object S0 in the image storage server 3. In this case, the virtual object acquisition unit 22 acquires the virtual object S0 from the image storage server 3.

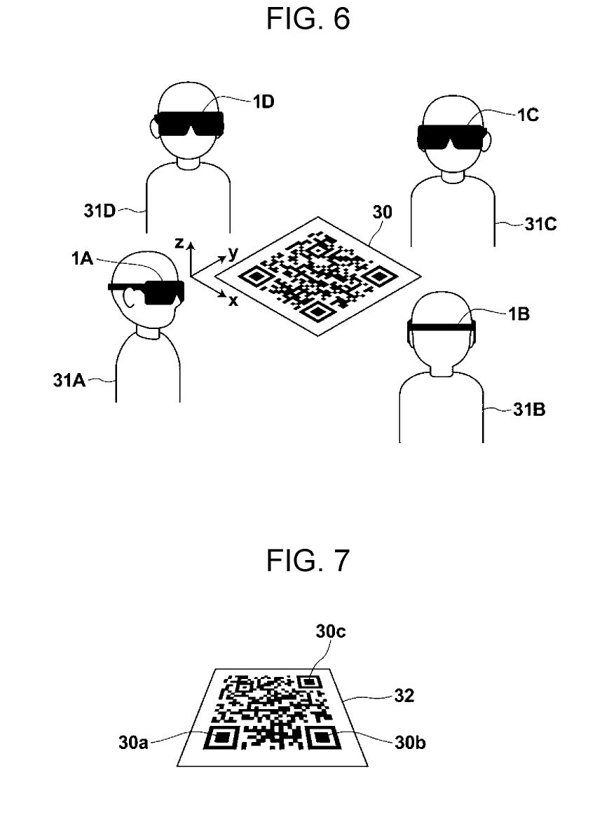

The display information acquisition unit 23 acquires, from the background video image B0, display information representing the position at which and the size and orientation in which the virtual object S0 is to be displayed. In this embodiment, the display information acquisition unit 23 acquires the display information from a marker image that is included in the background video image B0 as a result of imaging a first marker used to display the virtual object and that represents the first marker. FIG. 5 is a diagram illustrating the first marker. As illustrated in FIG. 5, a first marker 30 is created by affixing a two-dimensional barcode to a flat plate. Note that the first marker 30 may be a two-dimensional barcode printed on a sheet. The first marker 30 is placed at a place where a pre-surgery conference is held as illustrated in FIG. 6. Four participants 31A to 31D wear the HMDs 1A to 1D, respectively. In the HMDs 1A to 1D, the background video image B0 captured by the camera 14 is displayed on the display 15. The participants 31A to 31D turn their eyes toward the first marker 30 so that the background video image B0 displayed on the display 15 includes a first marker image 32 which is an image of the first marker 30.

The display information acquisition unit 23 extracts the first marker image 32 representing the first marker 30 from the background video image B0. FIG. 7 is a diagram illustrating the first marker image extracted from the background video image B0. The first marker image illustrated in FIG. 7 is an image acquired by the HMD 1A of the participant 31A. As illustrated in FIG. 5, the two-dimensional barcode of the first marker 30 includes three reference points 30a to 30c. The display information acquisition unit 23 detects the reference points 30a to 30c in the extracted first marker image 32. The display information acquisition unit 23 then determines the position at which and the size and orientation in which the virtual object S0 is to be displayed on the basis of the positions of the detected reference points 30a to 30c and intervals between the reference points.

In this embodiment, a position where the reference points 30a and 30b appear to be side by side is defined as the front position with respect to which the virtual object S0 is to be displayed. Thus, by detecting the positions of the reference points 30a and 30b in the first marker image 32, a rotation position of the virtual object S0 from the front position with respect to an axis (hereinafter, referred to as a z-axis) perpendicular to the first marker 30 can be determined. In addition, the size in which the virtual object S0 is to be displayed can be determined based on a difference of a distance between the reference points 30a and 30b from a predetermined reference value. Further, a rotation position of the virtual object S0 from a reference position with respect to two axes (hereinafter, referred to as an x-axis and a y-axis) that are perpendicular to the z-axis, that is, the orientation, can be determined based on a difference of a triangle having the reference points 30a to 30c as the vertices from a reference shape. The display information acquisition unit 23 outputs the determined position, size, and orientation of the virtual object S0 as the display information.

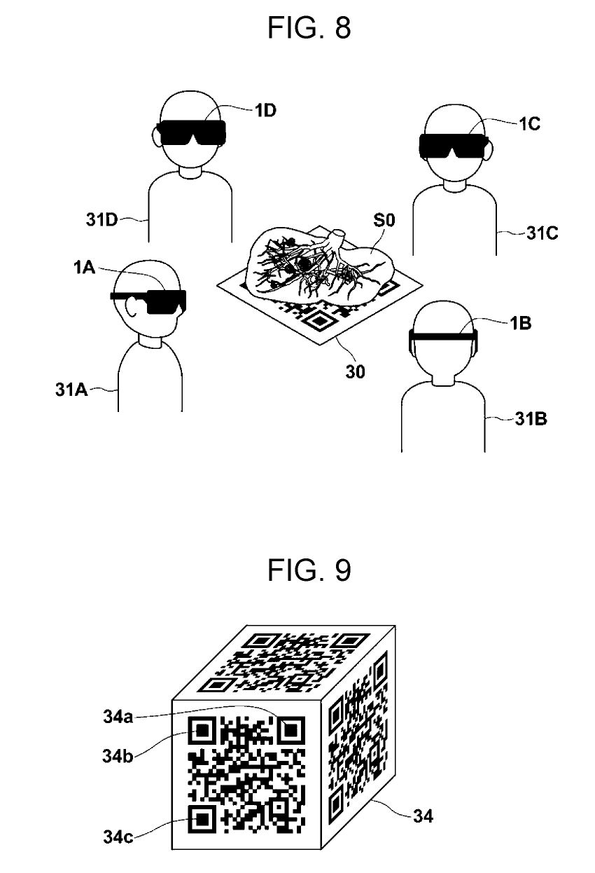

By using the display information, the display control unit 24 defines a projection plane onto which the virtual object S0 is to be projected and projects the virtual object S0 onto the projection plane. The display control unit 24 also superimposes the projected virtual object S0 on the background video image B0 and displays the resultant combined image on the display 15. FIG. 8 is a diagram schematically illustrating the display state of the virtual object S0 displayed at the place where the pre-surgery conference is held. As illustrated in FIG. 8, each of the participants 31A to 31D can observe, with the display 15, the state where a three-dimensional image of the liver having the size and orientation according to the position of the participant is displayed as the virtual object S0 on the first marker 30 that exists in the real space.

Note that the display control unit 24 displays the virtual object S0 on the display unit for the left eye and the display unit for the right eye of the display 15 such that the virtual object S0 has parallax. With this configuration, the participants can stereoscopically view the virtual object S0.

In addition, the participants can change the orientation of the virtual object S0 displayed on the display 15 by rotating or inclining the first marker 30 with respect to the z-axis in this state.

The change information acquisition unit 25 acquires, from the background video image B0, change information used to change the display state of the virtual object S0. Note that the color, brightness, contrast, opacity, sharpness, and the like of the virtual object S0 can be defined as the display state. It is assumed in this embodiment that the opacity is defined. In this embodiment, the change information acquisition unit 25 acquires the change information from a marker image that is included in the background video image B0 as a result of imaging a second marker used to change the display state of the virtual object S0 and that represents the second marker. FIG. 9 is a diagram illustrating the second marker. As illustrated in FIG. 9, a second marker 34 is created by affixing two-dimensional barcodes to respective faces of a cube. Note that the second marker 34 may be obtained by printing two-dimensional barcodes on respective faces of a net of a cube and by folding the net into a cube.

Although the opacity is defined as the display state in the two-dimensional barcodes affixed to all the faces in this embodiment, two-dimensional barcodes that define different display states may be affixed to different faces. For example, two-dimensional barcodes that define the color, brightness, and sharpness as well as the opacity may be affixed to the respective faces of the cube.

When a pre-surgery conference is held, the surgeon who explains the surgery holds the second marker 34. The surgeon holds the second marker 34 such that the second marker 34 is in the imaging range of the camera 14 of the HMD 1 of the surgeon. Note that a frontal view of any of the six faces of the second marker 34 is just required to be included in the background video image B0. In this way, a second marker image 35 of the second marker 34 is displayed on the display 15. In addition, in the case where the second marker 34 having faces to which two-dimensional barcodes that define different display states are affixed is used, the surgeon may hold the second marker 34 such that the two-dimensional barcode that defines the display state to be changed is included in the background video image B0.

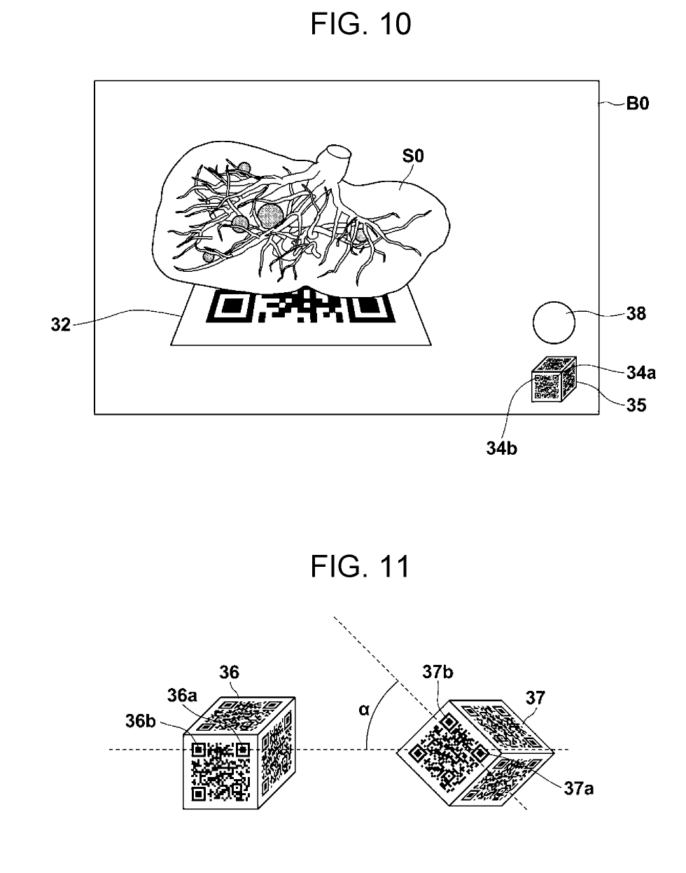

The change information acquisition unit 25 extracts the second marker image 35 representing the second marker 34 from the background video image B0. In this embodiment, the surgeon changes inclination of the second marker 34 with respect to the horizontal plane of the background video image B0 displayed on the display 15 in order to change the display state of the virtual object S0. FIG. 10 is a diagram for describing changing of inclination of the second marker 34.

Note that it is assumed in this embodiment that the display state of the virtual object S0 is changed by rotating the second marker 34 clockwise with respect to the background video image B0. Thus, as the amount of clockwise rotation increases, the amount of change in the display state increases.

In this embodiment, the amount of change in the display state of the virtual object S0 is defined in accordance with an angle of a line connecting reference points 34a and 34b among three reference points 34a to 34c included in the second marker 34 with respect to the horizontal plane of the background video image B0. Thus, the change information acquisition unit 25 detects the reference points 34a and 34b in the extracted second marker image 35. Then, the change information acquisition unit 25 defines a line connecting the detected reference points 34a and 34b and calculates the angle of the line with respect to the horizontal plane of the background video image B0.

In this embodiment, only the change information acquisition unit 25 of the HMD 1 worn by the surgeon acquires the change information and transmits via the network 4 the acquired change information to the HMDs 1 worn by the other participants.

The change information acquisition unit 25 acquires a ratio of the calculated angle to 360 degrees as the change information. For example, when the angle is equal to 0 degrees, the change information indicates 0. When the angle is equal to 90 degrees, the change information indicates 0.25.

Note that the HMD 1 is equipped with the gyro sensor 17 for detecting movement of the wearer. Thus, the gyro sensor 17 may detect the horizontal plane of the HMD 1, and the angle of the line connecting the reference points 34a and 34b may be calculated by using the horizontal plane detected by the gyro sensor 17 as a reference.

In addition, two second markers 36 and 37 may be prepared, a relative angle between the two markers 36 and 37 may be calculated, and the change information may be acquired based on this angle. For example, as illustrated in FIG. 11, an angle α at which a line passing through reference points 36a and 36b of one of the markers, i.e., the marker 36, and a line passing through reference points 37a and 37b of the other marker 37 intersect may be calculated, and a ratio of the calculated angle to 360 degrees may be acquired as the change information. Note that in this case, if one of the second markers is placed on a table or the like, the other second marker can be operated by one hand. Thus, an operation to change the display state is easy.

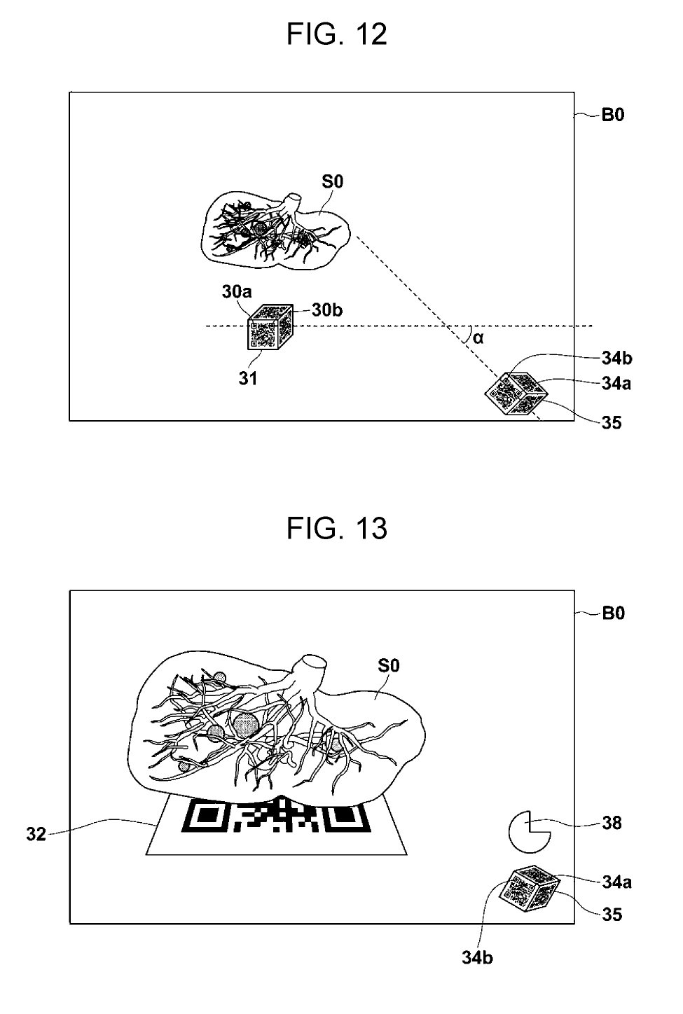

Further, the first marker 30 may be configured as a cube having faces to which two-dimensional barcodes are affixed just like the second marker 34, a relative angle of the second marker image 35 with respect to a horizontal plane defined by a first marker image 31 may be calculated, and the change information may be acquired based on this relative angle. For example, as illustrated in FIG. 12, an angle α at which a line passing through the reference points 30a and 30b in the first marker image 31 and a line passing through the reference points 34a and 34b in the second marker image 35 intersect may be calculated, and a ratio of the calculated angle to 360 degrees may be acquired as the change information.

Note that the second marker 34 may be operated by holding the second marker 34 with a hand in the first embodiment. Alternatively, the second marker 34 may be placed on a table. In this case, since the second marker 34 is rotated only in unit of 90 degrees, the display state can no longer be changed continuously but the surgeon no longer needs to hold the second marker 34 with the hand all the time.

The display state changing unit 26 changes the display state of the virtual object S0 by using the change information acquired by the change information acquisition unit 25. For example, in the case where the opacity of the virtual object S0 is equal to 1.00 in the initial state and the change information indicates 0.25, the display state changing unit 26 changes the opacity to 0.75.

In the case where the angle of the line connecting the reference points 34a and 34b of the second marker 34 with respect to the horizontal plane of the background video image B0 is equal to 0 as illustrated in FIG. 10, the display state of the virtual object S0 is not changed from the initial state. If the second marker 34 is inclined and consequently the angle of the line connecting the reference points 34a and 34b with respect to the horizontal plane of the background video image B0 increases, the opacity of the virtual object S0 decreases.

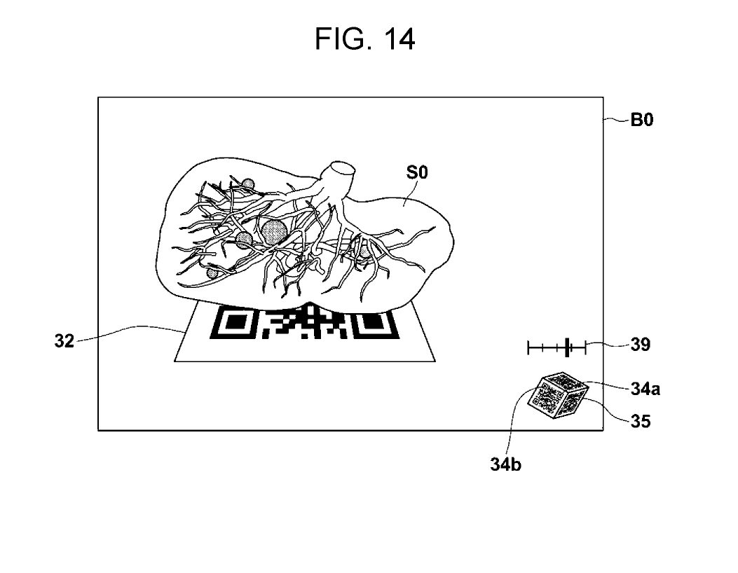

The set amount display control unit 27 displays, on the display 15, information representing a set amount of the display state of the virtual object S0. In this embodiment, a pie chart is used as the information representing the set amount. As illustrated in FIG. 10, the set amount display control unit 27 displays a pie chart 38 above the second marker image 35 as the information representing the set amount. Note that FIG. 10 illustrates the pie chart 38 in the case where the opacity is equal to 1.00 as the initial state. When the angle of the second marker 34 is changed to 90 degrees, the change information changes to 0.25. Thus, the pie chart 38 changes to indicate that the opacity is equal to 0.75 as illustrated in FIG. 13. Note that a bar chart may be used instead of the pie chart. The information representing the set amount may be a graduated scale 39 as illustrated in FIG. 14 or may be a numerical value indicating the set amount. In addition, the display position of the information representing the set amount is not limited to the position above the second marker image 35 and may be on the left or right of or below the second marker image 35 as long as both the second marker image 35 and the information representing the set amount can be recognized without moving the line of sight. Further, the information representing the set amount may be superimposed on the second marker image 35. Also, the information representing the set amount may be displayed at a given position on the display 15.

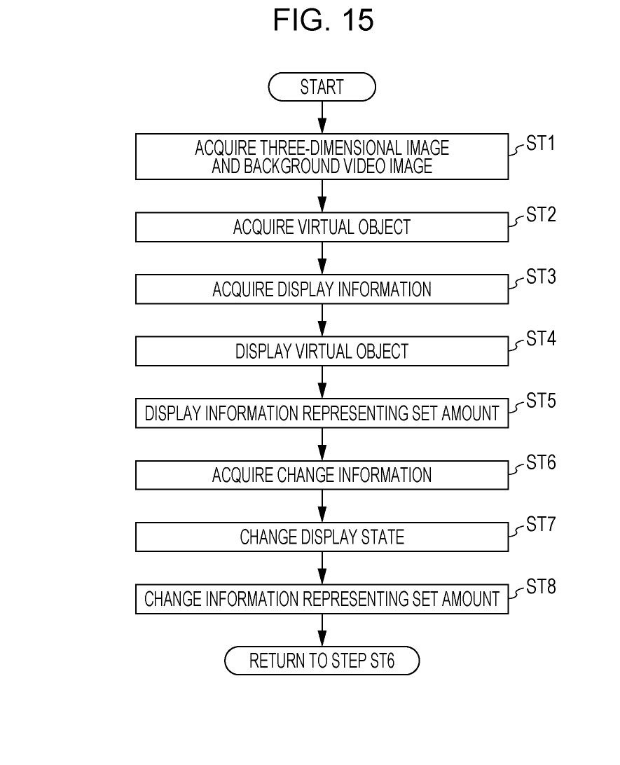

A process performed in the first embodiment will be described next. FIG. 15 is a flowchart illustrating the process performed in the first embodiment. Note that it is assumed that the first marker 30 is placed at a place where a pre-surgery conference is held and the surgeon is holding the second marker 34 with the hand.

First, the image acquisition unit 21 acquires the three-dimensional image V0 and the background video image B0 (step ST1). The virtual object acquisition unit 22 acquires the virtual object S0 from the three-dimensional image V0 (step ST2). In addition, the display information acquisition unit 23 extracts the first marker image 32 representing the first marker 30 from the background video image B0 and acquires, from the first marker image 32, display information representing the position at which and the size and orientation in which the virtual object S0 is to be displayed (step ST3). Then, the display control unit 24 superimposes the virtual object S0 on the background video image B0 and displays the resultant combined image on the display 15 by using the display information (step ST4). Consequently, the participants of the pre-surgery conference who are wearing the HMDs 1 can observe the state where the virtual object S0 is displayed in the real space. Note that the virtual object S0 can be inclined or rotated by inclining the first marker 30 or rotating the first marker 30 around the axis (z-axis) perpendicular to the two-dimensional barcode in this state. In addition, once the virtual object S0 is displayed, the set amount display control unit 27 displays, on the display 15, information representing a set amount of the display state of the virtual object S0 (step ST5).

Then, the change information acquisition unit 25 extracts the second marker image 35 representing the second marker 34 from the background video image B0, calculates an angle of the second marker image 35 with respect to the horizontal plane of the background video image B0, and acquires change information regarding the display state of the virtual object S0 from the calculated angle (step ST6). Then, the display state changing unit 26 changes the display state of the virtual object S0 by using the change information (step ST7). Further, the set amount display control unit 27 changes the information representing the set amount of the display state and displays the information on the display 15 (step ST8). The process then returns to step ST6.

As described above, in this embodiment, the display state of the virtual object S0 is changed in accordance with the change information, and the information representing the set amount of the display state of the virtual object S0 is displayed. Therefore, the wearer can recognize the set value of the current display state of the virtual object S0 by viewing the displayed information representing the set amount and consequently can accurately change the display state of the virtual object S0.

In addition, as the change information is acquired from the second marker image 35 that is included in the background video image B0 and that represents the second marker 34, the change information can be acquired in response to movement of the second marker 34 or the like. Thus, the display state of the virtual object S0 can be changed in response to an actual operation.

In addition, since the display state of the second marker image 35 and the information representing the set amount can be easily associated with each other by displaying the information representing the set amount to be adjacent to the second marker image 35, the display state of the virtual object S0 can be changed easily.

In addition, the use of a cube having faces each of which is assigned information used to change the display state as the second marker 34 makes it possible to easily change the display state of the virtual object S0 simply by rotating or moving the cube.

Note that in the first embodiment described above, only the surgeon who is the representative of the pre-surgery conference holds the second marker 34, and the display state of the virtual object S0 displayed on the HMDs 1 worn by all the participants is changed in response to an operation performed by the surgeon. However, the participants may hold their own second markers 34. In this case, the second markers 34 of the respective participants can be distinguished from one another by changing the two-dimensional barcodes affixed to the second markers 34 for individual participants. Thus, each participant captures images of their second marker 34 by using the camera 14 of the HMD 1 thereof and registers the second marker image 35 in the HMD 1 thereof. Then, the change information acquisition unit 25 of each HMD 1 acquires change information only when an angle of a line connecting reference points of the registered second marker image 35 with respect to the horizontal plane of the background video image B0 is changed.

Then, after the virtual object S0 is displayed, each participant captures an image of the second marker 34 by using the camera 14 so that the second marker image 35 is included in the background video image B0. When the participant desires to change the display state of the virtual object S0 displayed on the HMD 1 thereof, the participant operates the second marker 34 held thereby to change the angle of the line connecting the reference points of the second marker image 35 with respect to the horizontal plane of the background video image B0. The change information acquisition unit 25 then acquires the change information, and the display state changing unit 26 changes the display state of the virtual object S0. In this case, the display state of the virtual object S0 displayed to the other participants is not changed. The information representing the set amount, which is displayed on the display 15 by the set amount display control unit 27, is based on the amount of change in the angle of the line connecting the reference points of the registered second marker image 35 with respect to the horizontal plane of the background video image B0.

As described above, each participant holds the second marker 34, registers the second marker image 35, and changes the display state of the virtual object S0. In this way, each participant can change the display state of the virtual object S0 without influencing the display state of the virtual object S0 displayed to the other participants.

In addition, in the embodiment described above, the display state of the entire virtual object S0 is changed by using the second marker 34. However, the virtual object S0 displayed in the first embodiment includes other objects, such as the liver and the arteries, veins, portal vein, and lesion included in the liver. Accordingly, the display state may be changed for each of the objects, such as the liver, arteries, veins, portal vein, and lesion. This will be described as a second embodiment below.

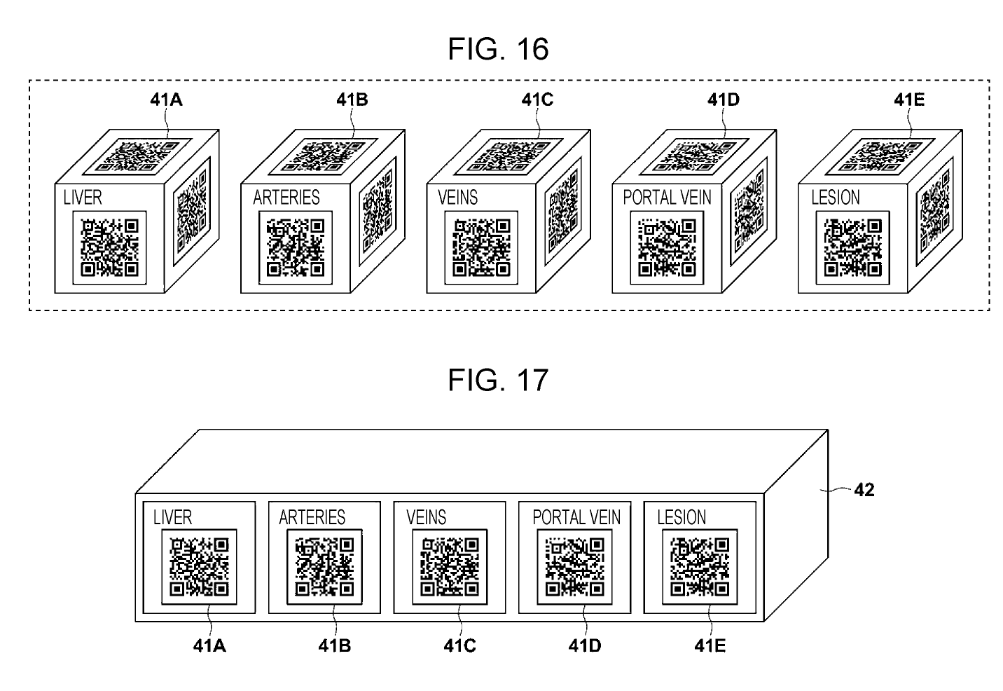

FIG. 16 is a diagram illustrating second markers used in the second embodiment. As illustrated in FIG. 16, five second markers 41A to 41E are used in the second embodiment. The names of the objects are written on the respective markers 41A to 41E to indicate for which of the objects included in the virtual object S0 each of the markers is used to change the display state. Specifically, the liver, the arteries, the veins, the portal vein, and the lesion are respectively written on the markers 41A to 41E. Since it is difficult to operate the plurality of second markers 41A to 41E by holding the markers with the hand, the second markers 41A to 41E are preferably placed on a table not illustrated. In addition, two-dimensional barcodes that define different display states may be affixed to different faces of each of the second markers 41A to 41E, and the face of each of the second markers 41A to 41E displayed on the display 15 may be changed by rotating the corresponding one of the second markers 41A to 41E. In this way, the display state of each object constituting the virtual object S0 may be changed. In this case, it is preferable that the second markers 41A to 41E be housed in a case 42 as illustrated in FIG. 17 so that faces other than the face having the two-dimensional barcode that defines the display state desired to be set are not seen and that the second markers 41A to 41E be taken out from the case 42 when necessary to change the orientation of the second markers 41A to 41E so that the desired face is imaged.

As described above, the second markers 41A to 41E used to change the display states of the respective objects that constitute the virtual object S0 are prepared, and change information (object change information) is acquired for each of the second markers 41A to 41E, that is, for each of the objects included in the virtual object S0. In this way, the display states of the respective objects included in the virtual object S0 can be made different. In particular, by using a two-dimensional barcode that defines hiding as the display state, a desired object can be hidden in the virtual object S0. Accordingly, each of the objects included in the virtual object S0 can be observed in a desired display state.

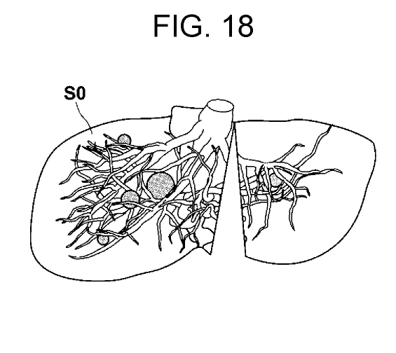

In addition, in the embodiments described above, a simulation motion picture regarding the progress of a surgery may be created in advance by using the virtual object S0, and a change in the shape of the virtual object S0 in accordance with the progress of the surgery over time may be defined as the display state. In this case, the display state of the virtual object S0 can be changed by operating the second marker 34 so that the virtual object S0 changes from the state illustrated in FIG. 4 to, for example, the state where the liver is resected as illustrated in FIG. 18.

In addition, a plurality of plans may be prepared as surgery plans, and simulation motion pictures regarding the progress of the surgery may be created for the respective plans. In this case, simulation motion pictures of different plans are associated with different two-dimensional barcodes that are affixed to the respective faces of the second marker. Then, by displaying on the display 15 the two-dimensional barcode on the face for which a plan desired to be displayed is defined, the display state of the virtual object S0 can be changed on the basis of the simulation motion picture of the surgery plan.

In addition, although the first marker obtained by affixing a two-dimensional barcode to a plate is used in the embodiments described above, a predetermined symbol, color, drawing, character, or the like may be used instead of the two-dimensional barcode. In addition, the first marker may be a predetermined object, such as an LED, a pen, or an operator's finger. Further, a texture such as an intersection of lines or a shining object included in the background video image B0 may be used as the first marker.

In addition, in the case where the two markers 36 and 37 are used as illustrated in FIG. 11, two markers each having faces that are assigned different colors instead of two-dimensional barcodes may be used. In this case, the change information may be defined in accordance with the combination of colors of the two markers. For example, in the case where markers each having faces that are assigned six colors of red, blue, green, yellow, purple, and pink are used, the change information may be defined for each combination of colors of the two markers such that a combination of red and red indicates 1.00 and a combination of red and blue indicates 0.75. In addition, two markers each having faces that are assigned different patterns instead of colors may be used. In this case, the change information may be defined in accordance with a combination of patterns of the two markers. Note that the number of markers is not limited to two and may be three or more. In this case, the change information may be defined in accordance with a combination of three or more colors or patterns.

In addition, a marker having faces that are assigned numerals instead of two-dimensional barcodes may be used. In this case, the numerals are defined as percentage values, and numerals such as 100, 75, and 50 are assigned to the respective faces of the second marker. The change information represented by the percentage value may be acquired by reading the numeral on the second marker included in the background video image B0.

In addition, although the second marker obtained by affixing two-dimensional barcodes to a cube is used in the embodiments described above, the second marker is not limited to a cube and may be another polyhedron, such as a tetrahedron or an octahedron. In this case, two-dimensional barcodes that define different display states may be affixed to respective faces of a polyhedron or the same two-dimensional barcode may be affixed. In addition, the second marker is not limited to a polyhedron, and a marker obtained by affixing a two-dimensional barcode to a plate just like the first marker 30 may be used as the second marker. With such a configuration, the display state of the virtual object can be changed more easily by rotating or moving a polyhedron.

In addition, the display state of the virtual object S0 is changed by rotating the second marker 34 on the plane of the display 15 in the embodiments described above. However, the display state of the virtual object S0 may be changed by rotating the second marker 34 forward or backward in the depth direction of the plane of the display 15. In this case, the change information may be acquired on the basis of a change in the shape of the two-dimensional barcode affixed to the second marker 34. In addition, the display state of the virtual object S0 may be changed by moving the second marker 34 to be closer to or farther from the camera 14. In this case, the change information may be acquired on the basis of a change in the size of the second marker image 35 displayed on the display 15. In addition, in the case where the two second markers 36 and 37 are used as illustrated in FIG. 11, a relative distance may be calculated instead of the relative angle between the two markers 36 and 37 and the change information may be acquired on the basis of this relative distance. In addition, in the case where a relationship with the first marker image 31 is used as illustrated in FIG. 12, a relative distance may be calculated instead of the relative angle between the first marker image 31 and the second marker image 35 and the change information may be acquired on the basis of this relative distance.

In addition, although the second marker to which two-dimensional barcodes are affixed is used in the embodiments described above, predetermined symbols, colors, drawings, characters, or the like may be used instead of two-dimensional barcodes. In addition, the second marker may be a predetermined object, such as an LED, a pen, or an operator's finger. In such a case, an amount by which an LED or the like is moved from the initial position may be detected, and this amount may be used as the change information.

In addition, the HMD 1 is equipped with the camera 14 in the embodiments described above. However, the camera 14 may be provided separately from the HMD 1. In this case, the camera 14 is also preferably arranged to image the range corresponding to the field of view of the wearer of the HMD 1.

In addition, in the embodiments described above, the virtual object display device according to an aspect of the present invention is applied to an HMD, which is an immersive-type eyeglass-shaped display device. However, the virtual object display device according to the aspect of the present invention may be applied to a see-through-type eyeglass-shaped display device. In this case, the display 15 is a see-through-type display, and as a result of displaying the virtual object S0 on the display 15, the wearer of the virtual object display device can observe the virtual object S0 superimposed on the real space which the wearer is actually viewing, instead of the background video image B0 that is captured by the camera 14 and is displayed on the display 15. In addition, in this case, the camera 14 is used to image the first marker 30 used for determining the position at which and the size in which the virtual object S0 is to be displayed and to image the second marker 34 used for changing the display state of the virtual object S0.

In addition, in the embodiments described above, the virtual object display device according to an aspect of the present invention is applied to an eyeglass-shaped display device. However, the virtual object display device according to the aspect of the present invention may be applied to a camera-equipped tablet terminal. In this case, participants of a pre-surgery conference carry tablet terminals, and the background video image B0 and the virtual object S0 are displayed on the displays of the tablet terminals.

In the embodiments described above, the position at which and the size and orientation in which the virtual object S0 is to be displayed is acquired as the display information by using the first marker 30, and the virtual object S0 having the size and orientation according to the position of each participant of the pre-surgery conference is displayed.

In addition, although the virtual object S0 generated from a three-dimensional medical image is displayed in the embodiments described above, the type of the virtual object S0 is not limited to a medical object. For example, a game character, a model, or the like may be used as the virtual object S0.

Advantageous effects of the present invention will be described below.

Since a virtual object can be displayed in a user's field of view by imaging a background corresponding to the user's field of view and acquiring a background video image, observation of the virtual object can be performed easily.

In addition, the virtual object can be displayed in the appropriate size and/or orientation by including, in display information, at least one of a size and an orientation in which the virtual object is to be displayed.

In addition, it is advantageous to combine the virtual object with the background video image and to display the resultant combined image when the virtual object is displayed particularly by using an immersive-type eyeglass-shaped display device.

In addition, since acquisition of display information from the first marker image that is included in the background video image as a result of imaging the first marker used to display the virtual object and that represents the first marker allows the virtual object to be displayed at the position where the first marker is placed, the virtual object can be displayed at the position desired by the user in the real space.

In addition, as the change information is acquired from the second marker image that is included in the background video image as a result of imaging the second marker used to change the display state of the virtual object and that represents the second marker, the change information can be acquired in response to movement of the second marker or the like. Thus, the display state of the virtual object can be changed in response to an actual operation.

In addition, the use of an amount of change of the second marker from the reference position as the change information makes it possible to easily change the display state of the virtual object by moving the second marker from the reference position.

In addition, since the display state of the second marker image and the information representing the set amount can be easily associated with each other by displaying the information representing the set amount to be adjacent to the second marker image, the display state of the virtual object can be changed easily.

In addition, the use of a polyhedron having faces each of which is assigned information used to change the display state as the second marker makes it possible to change the display state of the virtual object more easily by rotating or moving the polyhedron.

In addition, the use of a eyeglass-shaped display device as the display device makes it possible to display a virtual object having parallax for the left and right eyes, and consequently the virtual object can be seen stereoscopically. Therefore, the virtual object can be observed in a more realistic manner.

### REFERENCE SIGNS LIST

1, 1A-1D head-mounted display (HMD)
2 three-dimensional imaging apparatus
3 image storage server
4 network
11 CPU
12 memory
13 storage
14 camera
15 display
16 input unit
17 gyro sensor
21 image acquisition unit
22 virtual object acquisition unit
23 display information acquisition unit
24 display control unit
25 change information acquisition unit
26 display state changing unit
27 set amount display control unit
30 first marker
34, 36, 37 second marker

What is claimed is:

1. A virtual object display device comprising:
an imaging unit that acquires a background video image;
a virtual object acquisition unit that acquires a virtual object;
a display unit on which the virtual object is displayed;
a display information acquisition unit that acquires, from the background video image, display information representing a position at which the virtual object is to be displayed;
a display control unit that displays the virtual object on the display unit on the basis of the display information;
a change information acquisition unit that acquires, from the background video image, change information used to change a display state of the virtual object;
a display state changing unit that changes the display state of the virtual object in accordance with the change information; and
a set amount display control unit that displays, on the display unit, information representing a set amount of the display state of the virtual object.

2. The virtual object display device according to claim 1, wherein the background video image is acquired by imaging a background that corresponds to a field of view of a user.

3. The virtual object display device according to claim 1, wherein the display information further includes at least one of a size and an orientation in which the virtual object is to be displayed.

4. The virtual object display device according to claim 2, wherein the display information further includes at least one of a size and an orientation in which the virtual object is to be displayed.

5. The virtual object display device according to claim 1, wherein the display unit combines the virtual object with the background video image and displays a resultant combined image.

6. The virtual object display device according to claim 2, wherein the display unit combines the virtual object with the background video image and displays a resultant combined image.

7. The virtual object display device according to claim 1, wherein the display information acquisition unit acquires the display information from a first marker image that is included in the background video image as a result of imaging a first marker used to display the virtual object and that represents the first marker.

8. The virtual object display device according to claim 1, wherein the change information acquisition unit acquires the change information from a second marker image that is included in the background video image as a result of imaging at least one second marker used to change the display state of the virtual object and that represents the second marker.

9. The virtual object display device according to claim 8, wherein the change information represents an amount of change of the second marker from a reference position.

10. The virtual object display device according to claim 8, wherein the set amount display control unit displays the information representing the set amount to be adjacent to the second marker image.

11. The virtual object display device according to claim 10, wherein the second marker is a polyhedron having faces each of which is assigned information used to change the display state.

12. The virtual object display device according to claim 11, wherein the polyhedron is a cube.

13. The virtual object display device according to claim 1, wherein
the virtual object includes a plurality of objects,
the change information acquisition unit acquires a plurality of pieces of object change information each for changing a display state of a corresponding one of the plurality of objects,
the display state changing unit changes the display state of each of the plurality of objects in accordance with a corresponding one of the pieces of object change information, and
the set amount display control unit displays, for each of the plurality of objects, information representing a set amount for the object on the display unit.

14. The virtual object display device according to claim 1, wherein the virtual object is a three-dimensional image.

15. The virtual object display device according to claim 14, wherein the three-dimensional image is a three-dimensional medical image.

16. The virtual object display device according to claim 1, wherein the display unit is an eyeglass-shaped display device.

17. A virtual object display system comprising:
a plurality of the virtual object display devices according to claim 1, each of the plurality of virtual object display devices corresponding to one of a plurality of users,
wherein the display state changing unit of each of the plurality of virtual object display devices changes the display state of the virtual object in accordance with the change information acquired by the change information acquisition unit of any one of the virtual object display devices.

18. A virtual object display system comprising:
a plurality of the virtual object display devices according to claim 1, each of the plurality of virtual object display devices corresponding to one of a plurality of users,
wherein the display state changing unit of each of the plurality of virtual object display devices changes the display state of the virtual object in accordance with the change information acquired by the change information acquisition unit of the virtual object display device.

19. A virtual object display method comprising:
acquiring a background video image;
acquiring a virtual object;
acquiring, from the background video image, display information representing a position at which the virtual object is to be displayed;
displaying the virtual object on display unit on the basis of the display information;
acquiring, from the background video image, change information used to change a display state of the virtual object;
changing the display state of the virtual object in accordance with the change information; and
displaying, on the display unit, information representing a set amount of the display state of the virtual object.

20. A non-transitory computer-readable recording medium storing a virtual object display program causing a computer to execute:
a step of acquiring a background video image;
a step of acquiring a virtual object;
a step of acquiring, from the background video image, display information representing a position at which the virtual object is to be displayed;
a step of displaying the virtual object on display unit on the basis of the display information;
a step of acquiring, from the background video image, change information used to change a display state of the virtual object;
a step of changing the display state of the virtual object in accordance with the change information; and
a step of displaying, on the display unit, information representing a set amount of the display state of the virtual object.
